(19) United States
(12) Patent Application Publication
(10) Pub. No.: US 2014/0033929 A1
(43) Pub. Date: Feb. 6, 2014

(54) DIGITAL ROLLER GRILL CONTROL APPARATUS

(71) Applicants: James E. Humphrey, Cheyenne, WY (US); Anthony M. Kukla, Fort Collins, CO (US)

(72) Inventors: James E. Humphrey, Cheyenne, WY (US); Anthony M. Kukla, Fort Collins, CO (US)

(21) Appl. No.: 13/901,024

(22) Filed: May 23, 2013

Related U.S. Application Data
(60) Provisional application No. 61/650,919, filed on May 23, 2012.

(51) Int. Cl. A47J 37/04; F24C 7/08

(52) U.S. Cl. CPC A47J 37/048; F24C 7/083
USPC 99/332; 99/441; 99/443 R

(57) ABSTRACT

A programmable control system for controlling the ratio of heating time “on” compared to time “off”. The digital control can be set to an “on”/“off” time duty cycle, and power level that determines the temperature of the cooking surface. The cooking surface can be divided into separately controllable zones. The need to actually sense the temperature at the roller tube is eliminated. The time based control can be set to cook at higher temperatures by increasing the “on time” relative to the “off time” or inversely, reducing the “on time” to the “off time”. A “pre-heat” cycle is provided to raise the grill to a predetermined set point for holding the elements full “on” for a selectable time period. Then, after the selectable time period has been reached, the control automatically sets the programmed “cook” time and temperature.

This application claims benefit of U.S. Provisional Application Ser. No. 61/650,919 filed on May 23, 2012 pursuant to 35 USC §119(e).

### FIELD OF THE INVENTION

This invention relates to commercial cooking assemblies, in particular, a temperature control system for a roller grill.

### BACKGROUND OF THE INVENTION

The use of a roller grill to cook hot dogs dates back at least as early as 1939. At that time, Dumas, in U.S. Pat. No. 2,185,979, recognized the advantage of using a plurality of rollers to quickly and uniformly cook hot dogs, bratwursts, sausages and other food products having an elongated shape. Since that time, the roller grill has been associated with America's food icon, the hot dog.

Heat controls in the prior art traditionally have used what is called an “infinite control”. The “infinite control” contains an internal heat switch that opens and closes the circuit with respect to temperature. As this switch opens and closes, the heating elements turn “on” and “off” for a certain period of time, thus creating a duty cycle.

Another system that has been used is having two or more settings, which can vary the number of elements that are “on” verses the number that are “off”. U.S. Pat. No. 6,707,015, issued to Huegerich et al. on Mar. 16, 2004 discloses the use of a control system that automatically adjusts the temperature of a roller grill without the involvement of an operator by use of a temperature sensor in communication with the control system.

There is not found in the prior art a control system for controlling the ratio of heat “on” compared to time “off” (duty cycle) using a digitally controlled timer. The digital control can be set by the user to a specific element “on”/“off” time duty cycle, this, in turn, determines the temperature of the cooking surfaces. This eliminates the need to actually sense the temperature at the roller tube, which is difficult due to the rotation of the tube. A time base control eliminates the need for temperature reading programming to feedback temperature information, which approximates the roller temperature, thus making costly probes and controls unnecessary. Further, there is no prior art having a time based control that can be set to cook at higher temperatures by increasing the “on time” relative to the “off time” or inversely, reducing the “on time” to the “off time”, such that the food can be held at lower temperatures for a longer period of time.

Additionally, no prior art device has a “pre-heat” cycle, which is provided to raise the grill to a predetermined set point for holding the elements full “on” for a selectable time period and, then, after the selectable time period has been reached, the control sets the pre-set “cook” time and temperature.

Finally, no prior art roller grill provides a feature that once a cycle has been completed, the control will reduce the “pre-heat” time or duty cycle for a predetermined amount of time for the next cycle.

### SUMMARY OF THE INVENTION

It is an aspect of the invention to provide a digital roller grill control apparatus that controls the ratio of heat “on” to “off” time.

It is another aspect of the invention to provide a digital roller grill control apparatus that measures the time the heating elements are “on” and compares that to the time the heating elements are “off”.

It is still another aspect of the invention to provide a digital roller grill control apparatus that provides the user with an approximated temperature of the product on the roller grill. This is accomplished by use of a temperature sensing device position in a manner to reflect the product temperature on the roller grill. This temperature sensor has no influence on controlling the duty cycle; it is only acting as a thermometer for the user.

Another aspect of the invention is to provide a digital roller grill control apparatus that eliminates the need to directly sense the temperature at the roller tubes while the roller tubes are turning.

Still another aspect of the invention is to provide a digital roller grill control apparatus that eliminates the need for a temperature reading and programming to provide feedback temperature information which approximates the roller grill temperature, thus, eliminating the need for costly probes and controls.

Another aspect of the invention is to provide a digital roller grill control apparatus that can be set to a higher temperature by increasing the “on” time relative to the “off” time.

Still another aspect of the invention is to provide a digital roller grill control apparatus that can hold the food product at a “hold” temperature by reducing the element “on” time to the element “off” time.

Another aspect of the invention is to provide a digital roller grill control apparatus that has a “pre-heat” cycle to raise the grill temperature to a predetermined set point by controlling the heating elements to a full “on” setting for a selectable time ranging from 0 to 999 minutes.

It is an aspect of the invention to provide a digital roller grill control apparatus that automatically goes into a “cook” mode once the “pre-heat” cycle time has been achieved.

Another aspect of the invention is to provide a digital roller grill control apparatus that can feature alarms for indicating the end of any cycle by use of lights or audible indicators well known in the art.

It is also an aspect of the invention to provide a digital roller grill control apparatus that is easy to program and operate.

Another aspect of the invention is to provide a digital roller grill control apparatus that has a display that can be easily interpreted when viewed at a distance.

It is still another aspect of the invention to provide a digital roller grill control apparatus that once one program cycle has been completed with program cycle defined as the completion of a “pre-heat”, “cook” and “hold” time has completed as the invention will automatically reduce the “pre-heat” time or cycle time by a predetermined amount on the next program cycle.

Finally, it is an aspect of the invention to provide a digital roller grill control apparatus that during the “hold” mode after a predetermined amount of time in that “hold” mode, the duty cycle will be reduced to extend the product “hold” time.

### BRIEF DESCRIPTION OF THE DRAWINGS

FIG. 1 is an isometric view of the digital roller grill control apparatus installed on a typical roller grill in accordance with the invention.

FIG. 2 is an exploded view of the digital roller grill control circuit board and relays.

FIG. 3 is a detailed view of the control panel.

FIG. 4 is an isometric view of the typical roller grill apparatus shown in FIG. 1 identifying the location of the temperature sensor on the apparatus.

FIG. 5 is a detailed view of the sensor identified in FIG. 4.

FIG. 6 is a side view of the typical roller grill apparatus shown in FIG. 1.

FIG. 7 is a detailed cross-sectional view of section C-C shown in FIG. 6.

FIG. 8 is an alternative isometric view of a roller grill apparatus with an optional warming drawer in accordance with the invention.

### DETAILED DESCRIPTION OF THE INVENTION

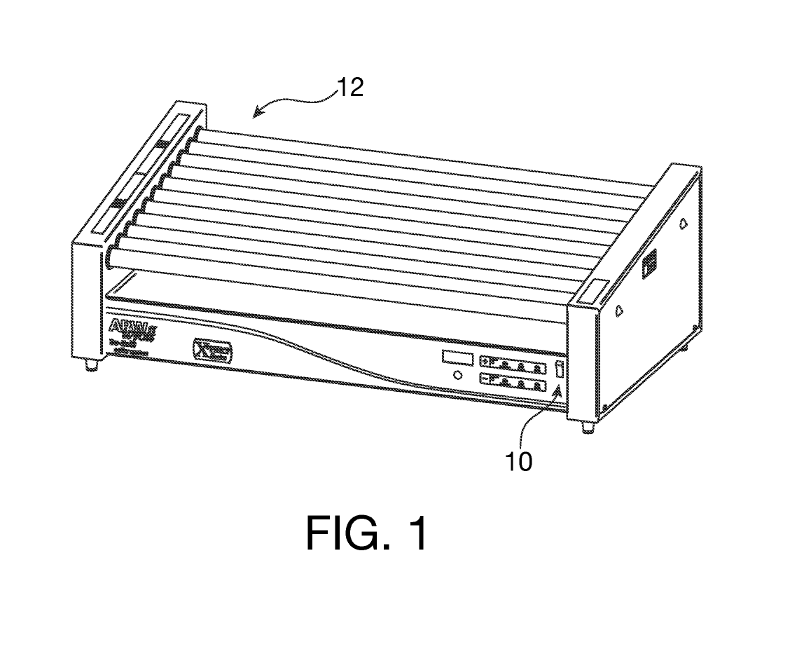

As shown in FIG. 1, the control panel of invention 10 is shown mounted on a typical roller grill apparatus 12. The typical roller grill apparatus 12 shown is Slant Model-50 HRDi made by APW Wyott of Dallas, Tex. However, the invention is not limited to this particular roller grill but could be used with any roller grill.

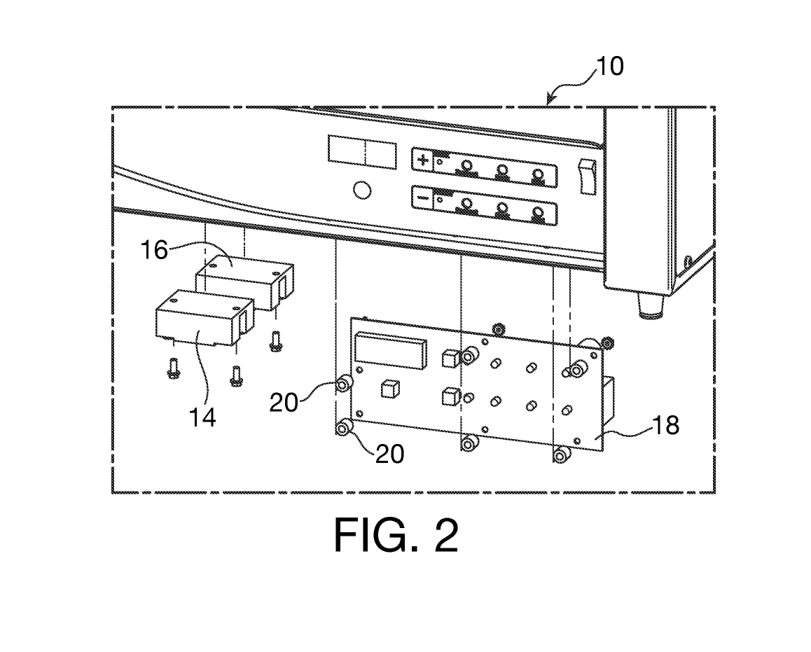

Referring now to FIG. 2, invention 10 is shown in an exploded view being mounted to the front panel of apparatus 12. The main components are circuit board 18 that is mounted to the front panel using spacers 20 and solid-state relays 14, 16 which are mounted to apparatus 12 using bolts. Circuit board 18 is preferably the type made by Quantum Corporation of Ewing, N.J.

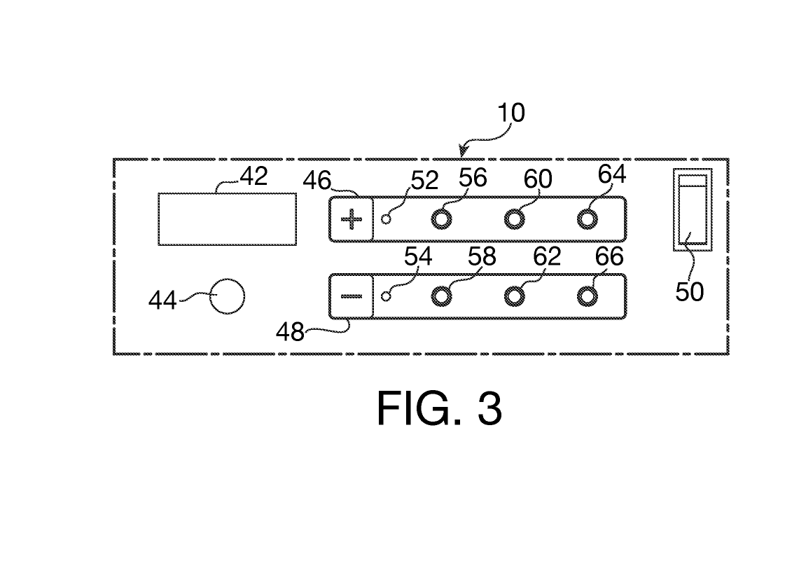

As shown in FIG. 3, the control panel of invention 10 includes an “on/off” switch 50; setting button 44; control buttons 46, 48; indicator lights 52, 54, 56, 58, 60, 62, 64 and 66; and display 42.

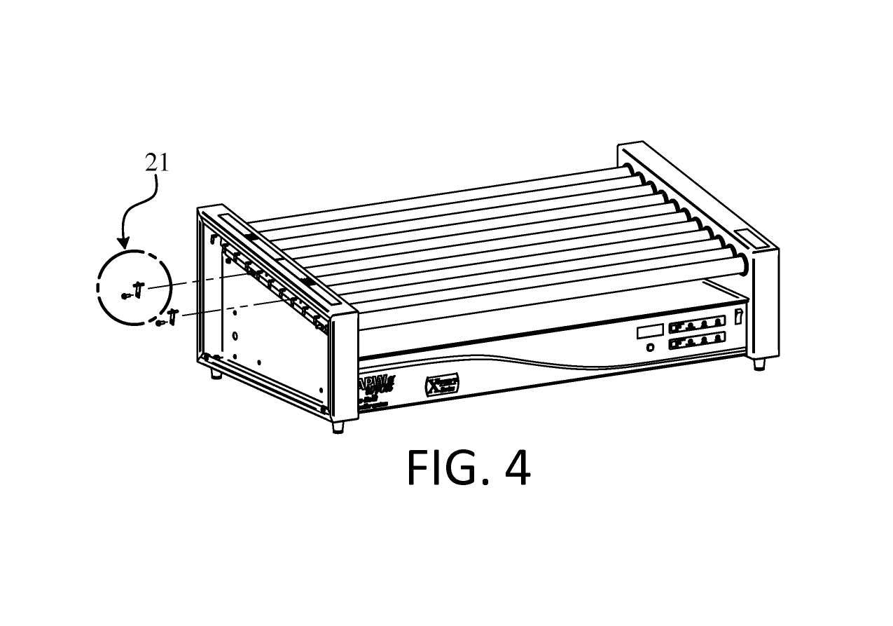

FIG. 4 shows the placement of temperature sensor assembly 21 on roller grill 12. Note that one sensor 21 is placed near the front of the roller grill, while another is placed near the rear so that the front part of the grill can be set at a different temperature than the rear rollers.

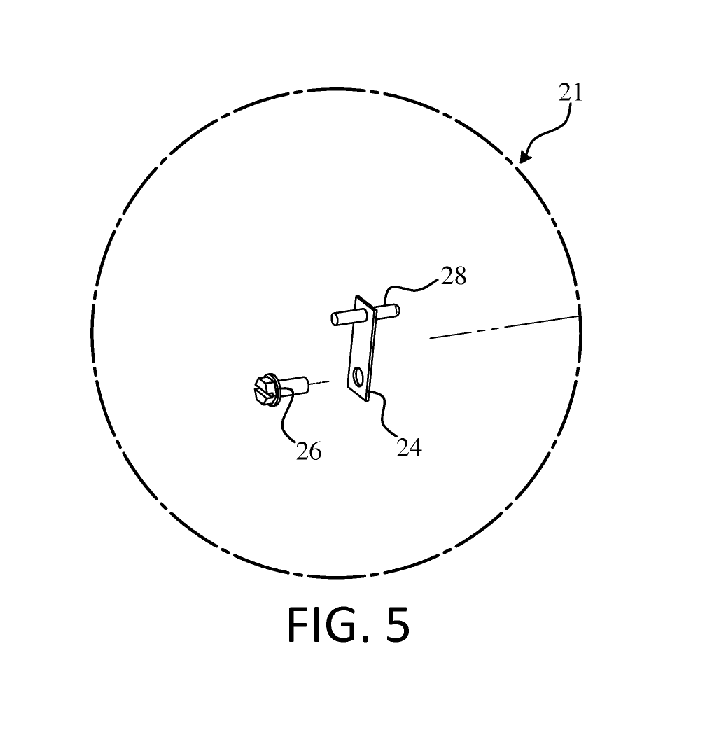

Referring to FIG. 5, sensor assembly 21 is described in detail. Sensor 28 is preferably a K-type thermocouple such as those made by Durex Industries of Cary, Ill. Assembly 21 is mounted to apparatus 12 using mounting plate 24 and screw 26 as shown in the exploded view.

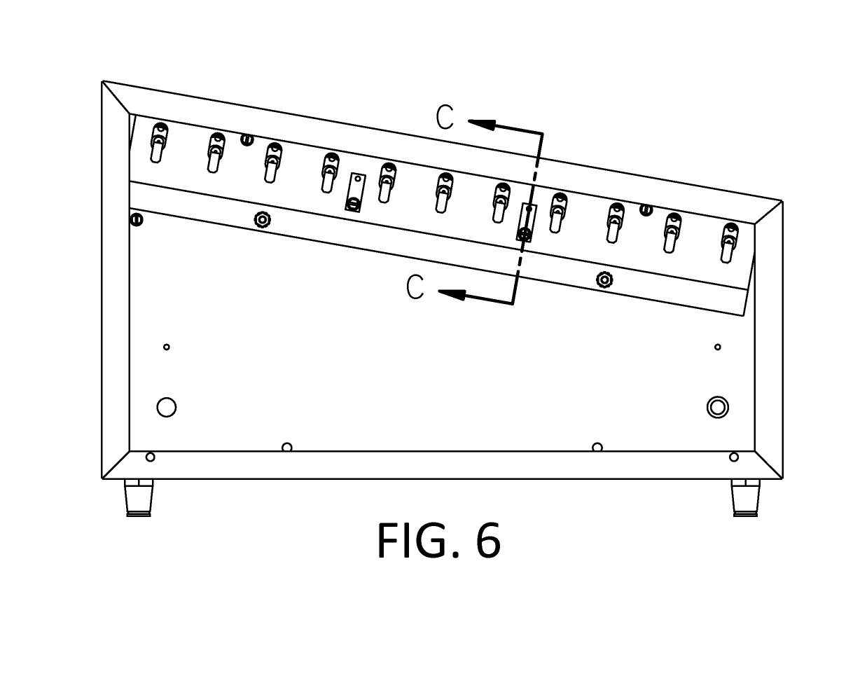

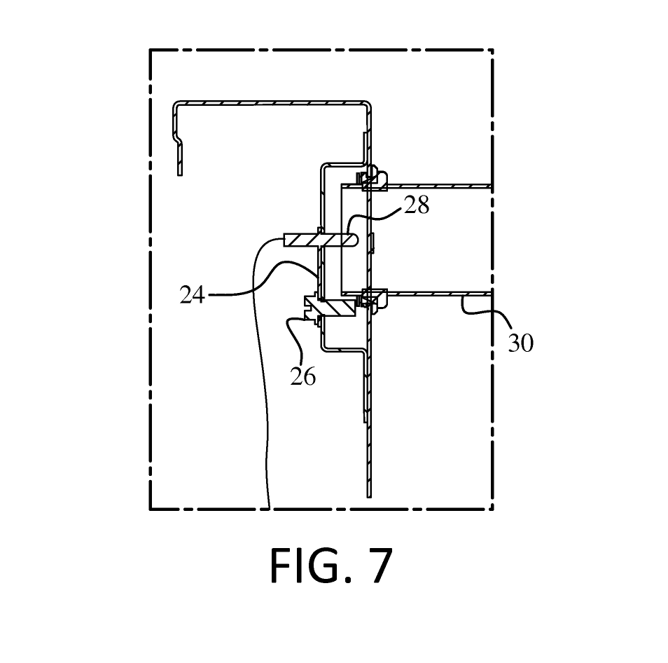

The preferential placement of sensor assemblies 21 is shown in FIGS. 6 and 7. Note that sensor 28 is immediately adjacent to one of the rollers of roller grill 12 with one assembly 21 in one of the front rollers and a second assembly 21 in one of the rear rollers, assuming that it is desired to be able to control the temperature of the front rollers at a different temperature than that of the rear rollers. The placement of sensor 28 is positioned so that it is centered between two roller tubes, isolated from the heating element. This was determined to be the best positioning to accurately reflect product temperature on the roller grill.

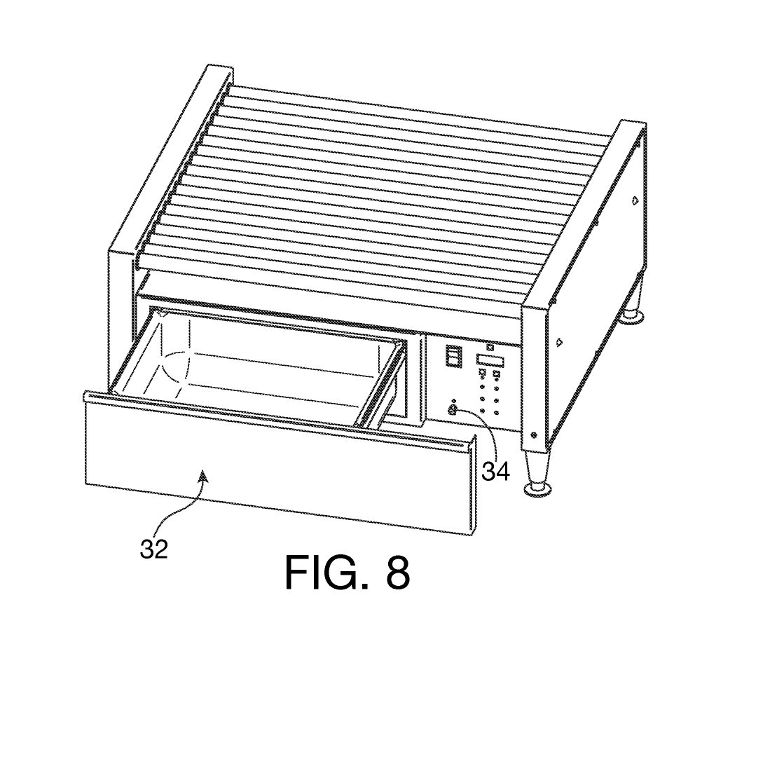

As shown in FIG. 8, invention 10 could also be used in an alternative embodiment with the control panel set in a vertical position rather than horizontal as shown in FIG. 1. In this embodiment, roller grill apparatus 12 features a bun warmer drawer 32 with a temperature control knob 34.

Referring back to FIG. 3, the operation of invention 10 is described in detail. Again, note that the preferred embodiment of invention 10 utilizes controls for both front and rear temperature control of the roller grill surface, however, that is not essential. Invention 10 could just as easily be used as a single temperature zone or even three or more zones depending on the user's needs and requirements.

The user will first turn on the apparatus by flipping rocker switch 50 to the “on” position. This will initiate power to invention 10 as well as turn on power to the rollers. LED display 42 will indicate “---” which tells the user that no mode of operation has been selected as yet. Button 46, rear indicator light 52, “pre-heat” light 56, “cook” light 60 and “hold” light 64 all relate to the operation and programming status of the rear zone of the roller grill surface of roller grill 12 while button 48, front indicator light 54, “pre-heat’ light 58, “cook” light 62 and “hold” light 66 all relate to the operation and programming status of the front zone of the roller grill surface of roller grill 12.

The operation and programming of the front roller grill surface only will be described in detail since the rear roller grill surface operation and programming is identical to the front zone except the user will use the rear button and lights instead of the front button and lights. Note that if both the front zone and rear zone are activated, display 42 will cycle between the front and rear zones.

To activate the front zone, button 48 is pushed once to initiate the “pre-heat” mode. Indicator light 54 becomes lighted throughout the entire cycle. Further, “pre-heat’ light 58 becomes lit indicating that the front zone of apparatus 12 is in the “pre-heat” mode. Display 42 shows the countdown time set by the user for the initial “pre-heat” time. During this time, the power to the heating elements is set to the initial “pre-heat” power level. Note that any time during the “pre-heat” mode, the user can hold down button 48 for approximately 3 seconds to change the mode to “cook”, if desired.

After the “pre-heat” time (shown on display) reaches zero, apparatus 12 automatically shifts to “cook” mode. Thus, “cook” indicator light 62 becomes lit and “pre-heat” indicator light 58 goes out. Display 42 now shows the countdown from the user set “cook” time. Again, during the “cook” mode, the user can hold down button 48 for approximately 3 seconds to change the mode to “hold”, if desired.

After the “cook” time ends, apparatus 12 automatically goes into “hold” mode. The “hold” indicator 66 becomes lit and “cook” light 62 goes out. The “hold” mode causes apparatus 12 to have the power drop to the “hold” temperature. Display 42 shows the product temperature based on the temperature measured at sensor 28 minus a factory provided offset. If the temperature is greater than a predetermined “hold” temperature, then display 42 reads “HI”; if too low, then display 42 reads “LOW”. Generally, any temperature less than 140 degrees Fahrenheit would cause display 42 to read “LOW” and any temperature greater than 180 degrees would cause display 42 to read “HI”.

It is important to note that there is no temperature adjustment or power adjustment by invention 10 using sensor 28. After “hold” time has counted down to zero, indicator lights 54, 58, 62 and 66 flash and apparatus 12 remains in “hold” mode until the user presses button 48 and then the elements in the front zone of the grill surface turn off.

As noted above, the rear zone is operated in the same manner as the front zone by using the rear zone button 46 and indicator lights 52, 56, 60 and 64. When both front and rear zones are operated at the same time, indicator lights and display 42 will cycle 10 seconds between front and rear zones. If apparatus 12 is in the “hold” mode for at least 30 minutes and the normal program cycle is started over, the “pre-heat” mode will use secondary “pre-heat” settings. To reset the unit to the initial “pre-heat” settings, merely turn switch 50 “off” and then back “on” again.

Invention 10 can be easily programmed by the user using buttons 46, 48 and display 42 in combination with setting button 44. Each mode, that is, “pre-heat”, “cook” and “hold” have power and time settings associated with it that are easily settable by the user.

To change the “pre-heat” setting, turn power switch 50 on. Note that there is only one “pre-heat” setting to control the front and rear zones. Immediately, press and hold setting button 44. Both zone indicator lights and “pre-heat” indicator lights will flash and display 42 will show the initial “pre-heat” power setting.

The “pre-heat” power settings can be changed from 1 through 10. The default setting is 10 which corresponds to 100% “on”. The power duty cycle of invention 10 is based on 10-second increments. If the user sets power to 4.5, for example, the elements in the roller tubes will cycle “on” for 4.5 seconds and “off” for 5.5 seconds. To decrease the setting from 10 to something lower, press button 48 (marked with indicia “−” which also indicates a minus sign thus reducing the power setting.) To increase the power setting from 4, for example, to 5, merely press button 46 (marked with indicia “+” which indicates a plus sign thus increasing the power setting.)

Again, pressing the setting button 44 will save the new “pre-heat” power level and cause display 42 to show the “pre-heat” time. Default “pre-heat” time is 15 minutes shown on display 42 as 00:15. The “pre-heat” time can be set from one minute to 10 hours in one-minute increments using the plus or minus buttons 46, 48.

Pressing setting button 44 again will save the new “pre-heat” time setting and cause display 42 to show the secondary “pre-heat” setting. Both front and rear zone lights 52, 54 will flash. Again, adjust the control panel using the plus or minus buttons 46, 48 respectively, as before.

Pressing setting button 44 will cause the new secondary power setting to be saved and display 42 will now show the secondary “pre-heat” time. Again, to change this time, use the plus or minus buttons 46, 48.

Press the setting button 44 to save the new secondary “pre-heat” time and both front and rear zone “hold” indicator lights 64, 66 will flash. Display 42 will show the whole setback power setting. Again, to change this time setting, press plus or minus button 46, 48. Press setting button 44 to save this new setting.

To program the “cook” and “hold” settings for either the front or rear zones, after turning the unit “on” using switch 50 or if just programming the prior setting options, display 42 must show “---”.

Begin by pressing and holding setting button 44 while also pressing and holding either the front or rear buttons 46, 48. This causes display 42 to indicate “cook” power for either the front or rear zone depending on which of button 46, 48 is used. Then, release both buttons. Change the level of “cook” power by pressing just the plus or minus button to increase or decrease the power level. Then, again, press just the setting button, which saves the new “cook” power level setting and also causes display 42 to show the “cook” time. Again, “cook” time is adjusted by using the plus or minus buttons. Pressing setting button 44 again, causes the new “cook” time to be saved and the display 42 now shows the “hold” power that by default is 45%.

Again, the “hold” power is adjusted using the plus or minus buttons 46, 48. Pressing setting button 44 again saves the new “hold” power level setting and causes the display to show the “hold” time setting. Again, the “hold” time setting is adjusted using the plus and minus buttons 46, 48. Pressing the setting button 44 again will save the new setting and display 42 will now indicate “---”. The other zone is programmed in the same manner except using its corresponding button 46 or 48. As before, zone button 46, 48 is now used and held with the setting button 44 and the process is repeated.

Although the present invention has been described with reference to certain preferred embodiments thereof, other versions are readily apparent to those of ordinary skill in the preferred embodiments contained here.

What is claimed is:

1. A programmable control system for a roller grill having a plurality of rollers that rotate and are heated electrically to provide a cooking surface, said system control comprising:
an on/off switch for turning on or off electrical power to said control system and the roller grill;
a digitally controlled timer adapted to provide a plurality of selectable time periods of operation and power levels being supplied to the heated rollers of the roller grill to control the temperature of the rollers and the time period operating at that temperature wherein each time period of operation and power level is defined as a mode of operation, wherein all modes of operation constitute a program cycle;
an LED display for indicating the time period and power level provided by said digitally controlled timer when the roller grill is operating in a particular mode; such that said display shows the time in that mode, as said display counts down until the time in that mode has been completed;
a setting button for programming the time period and power level for each mode of operation wherein each mode has a duty cycle defined as the ratio of the time that the heaters of the rollers are “on” relative to the time that heaters are “off”; and
at least one zone on the cooking surface of the roller grill corresponding to at least a portion of the cooking surface wherein the duty cycle of each of said modes provides a selectable surface temperature and time period for said at least one said zone, each of said at least one zone having a distinct zone indicator light;
a control button for said at least one zone wherein said control button causes one mode to change to the next mode; and when used in combination with said setting button, causes one power level to change to another, and can change the time period of operation for a mode.

2. The control system of claim 1 wherein said modes of operation are a “pre-heat” mode, a “cook” mode, and a “hold” mode.

3. The control system of claim 2 wherein each mode of operation further comprises an indicator light that relates to said mode selected.

4. The control system of claim 3 wherein the number of zones is two; one zone for the front portion of the cooking surface and a second zone for the rear portion of the cooking surface.

5. The control system of claim 4 further comprising a front indicator light that lights when said front zone is activated and a rear indicator light that lights when said rear zone is activated.

6. The control system of claim 1 wherein once said control button is pushed, a mode is activated and the initial time for that mode is displayed on said LED display and the initial power in accordance with the initial duty cycle for said mode is provided to the rollers of that zone.

7. The control system of claim 1 wherein if said control button is held down for a selectable period of time, a different mode of operation is selected and if said control button is held again for a selectable period of time, a still different mode of operation is selected and so on until all modes have been selected.

8. The control system of claim 2 wherein said control timer automatically advances said mode from “pre-heat” mode to “cook” mode to “hold” mode once the time period for that mode has elapsed as shown by said display.

9. The control system of claim 8 wherein said “pre-heat” indicator light goes out when that time period has elapsed and said “cook” indicator light lights when said “cook” mode is activated and goes out when said “cook” time period has been completed and said “hold” indicator light lights when said “hold” mode is activated and goes out when said “hold” time period has elapsed, wherein all of said indicator lights for the modes and zone flash after the time for said “hold” mode has elapsed until said cooking surface is turned off.

10. The control system of claim 1 wherein said control system can be programmed to change the time periods and power levels for each of said modes by using said setting button, said display and said control button for each said at least one zone.

11. The control system of claim 10 wherein pushing and holding said setting button will cause said zone indicator light for each at least one zone to light, will cause said mode indicator light to light and said display will show initial power setting for that mode, wherein the power level can be changed by pressing said control button associated with that said at least one zone, and pushing said setting button again will save the new power setting for that mode.

12. The control system of claim 11 wherein pushing said setting button again will cause said display to display the default time for that mode, wherein the time can be changed by using said control button.

13. The control system of claim 2 further comprising a temperature sensor for each said at least one zone wherein said display displays the temperature of the temperature of the product after completion of said “cook” mode wherein the product temperature is based on the temperature measured at said temperature sensor minus a factory-supplied offset such that if the temperature is greater than a predetermined value, said display will read “HI” and if the temperature is less than the predetermined value, said display will read “LOW” wherein said sensor makes no power or time adjustment to said control system.

14. The control system of claim 2 when said “hold” mode has been in operation for a predetermined amount of time, the duty cycle of the next program cycle starting with said “pre-heat” mode, said control system will automatically reduce the “pre-heat” settings.

15. A roller grill comprising:
a plurality of heatable, rotating rollers that provide a cooking surface, wherein the cooking surface is divided into at least one zone;
heating means for heating said plurality of rollers;
a digital control system that controls at least three modes of operation of said roller grill, wherein each mode of operation corresponds to a selectable power level that is supplied to said plurality of rollers for heating said plurality of rollers to a particular temperature and corresponds to a selectable time period for operating said at least one zone at that temperature; wherein said selectable power level corresponds to a period time in which said heating means is turned “on” and turned “off” thus setting the temperature of said at least one zone without the need for a temperature sensor at the rollers.

16. The roller grill of claim 15 wherein the power level of each mode of operation is programmable by a user using at least one button.

17. The roller grill of claim 15 wherein the selectable time period for operating in one of said at least modes is programmable by a user using at least one button.

18. The roller grill of claim 1 wherein the modes of operation are a “pre-heat” mode, a “cook” mode, and a “hold” mode.

19. The roller grill of claim 1 further comprising a warmer drawer with a temperature control to select the temperature at which said warmer drawer provides storage for products to be used with said grill and keeps the products at a desirable temperature.
